(19) United States
(12) Patent Application Publication
(10) Pub. No.: US 2001/0042145 A1
(43) Pub. Date: Nov. 15, 2001

(54) METHOD FOR COMBINING MULTIMEDIA DATA WITH AUDIO DATA FROM A COMPACT DISK

(76) Inventors: JENNIFER FROMMER, NEW YORK CITY, NY (US); IAN FROMMER, NEW YORK CITY, NY (US)

Correspondence Address: LERNER, DAVID, LITTENBERG, KRUMHOLZ& MENTLIK LLP,, 600 SOUTH AVENUE, WEST WESTFIELD, NJ, 07090, US

(21) Appl. No.: 09/067,652

(22) Filed: Apr. 27, 1998

(51) Int. Cl. G06F 13/10; G06F 15/16

(52) U.S. Cl. 710/58; 709/248

(57) ABSTRACT

The system and method of the invention operate to combine multimedia data with audio data from a compact disc, where the multimedia data is provided from a source separate from the compact disc. The separately supplied multimedia data and audio data from the compact disc are provided as inputs to a computer programmed to establish a linkage between the multimedia data and one or more selected portions of the compact disc audio data. The invention operates to establish and maintain a desired synchronous relationship between the multimedia data and the selected audio data. An output of the computer will be provided to audio and visual interface devices so as to provide an audio-visual representation of the synchronized audio and multimedia data for a user. In an exemplary embodiment, the multimedia data will be provided from a source accessed via the World Wide Web and the audio data will be extracted from the compact disc via a CD ROM player associated with the computer.

### FIELD OF THE INVENTION

This invention relates to digital audio media and more particularly to compact disc digital audio data.

### BACKGROUND OF THE INVENTION

Historically, audio recordings have presented a listener with a progression of technologies. Audio recording essentially started with the first practical phonograph developed by Thomas Alva Edison in 1877. The Edison phonograph utilized a cylinder as a recording media. In 1887 Emile Berliner developed a gramophone which used a flat-disk media played at 78 rpm. While the Edison device was originally intended for dictation, the gramophone rapidly became an artistic medium for recording the great singers and musical instrumentalists of the time. The very success of the recording media led to demands for improved sound. The next significant change to the recording media came in the late 1940's with the invention of the first fully practical long-playing record which operated at 33 rpm.

Early audio recording media utilized analog encoding which was susceptible to distortion and cumulative noise. Digital recording techniques offered a solution to the signal degradation and cumulative noise effects. The digital recorder measures the analog waveforms thousands of times each second and assigns a numerical value, or digit, to each of the measurements. These digits are then translated into a stream of electronic pulses that are placed in a memory bank for later retranslation and playback. Such techniques are used in Compact Disc (CD) recordings. The typical CD has the audio content stored in “Red Book” format.

Essentially, each significant improvement in audio quality has taken place at the cost of a change to a new recording media. For instance, many consumers have replaced their phonograph records with digital formats such as audio CDs in order to gain a significant improvement in audio quality. Recently, enhanced audio CDs have been released which contain interactive multimedia material. The enhanced CDs are typically played on a computer and provide interactive multimedia features. Although the enhanced CDs offer a multimedia experience, they do not provide improvement in the quality of the audio content, posing a dilemma for the listener and manufacturer. While a new audio release can be purchased in the enhanced CD format, the existing audio CD library, without justification of any improvement in audio quality, would have to be replaced in order to obtain the enhanced CD multimedia features. Previously released audio CDs are not currently being re-released in the enhanced CD format.

Accordingly, there is a need to provide enhanced CD capabilities for existing audio CDs.

### SUMMARY OF THE INVENTION

A methodology is disclosed for combining multimedia data with audio data from a compact disc, where the multimedia data is provided from a source separate from the compact disc. In particular, multimedia data from a source independent of the compact disc and audio data from the compact disc are provided as inputs to a computer programmed to establish a linkage between the multimedia data and one or more selected portions of the compact disc audio data. The computer further operates to establish and maintain a desired synchronous relationship between the multimedia data and the selected audio data. According to the method of the invention, an output of the computer will be provided to audio and visual interface devices so as to provide an audio-visual representation of the synchronized audio and multimedia data for a user. In an exemplary embodiment, the multimedia data will be provided from a source accessed via the World Wide Web and the audio data will be extracted from the compact disc via a CD ROM player associated with the computer. In one particularly advantageous embodiment of the invention, the multimedia data to be associated with the selected audio data may be dynamically varied according to user preference or other selected criteria.

### BRIEF DESCRIPTION OF THE DRAWINGS

A more complete understanding of the present invention may be obtained from consideration of the following description in conjunction with the drawings in which:

FIG. 1 is a diagram of a computer system utilizing the present invention system for combining multimedia data with audio data from a compact disc;

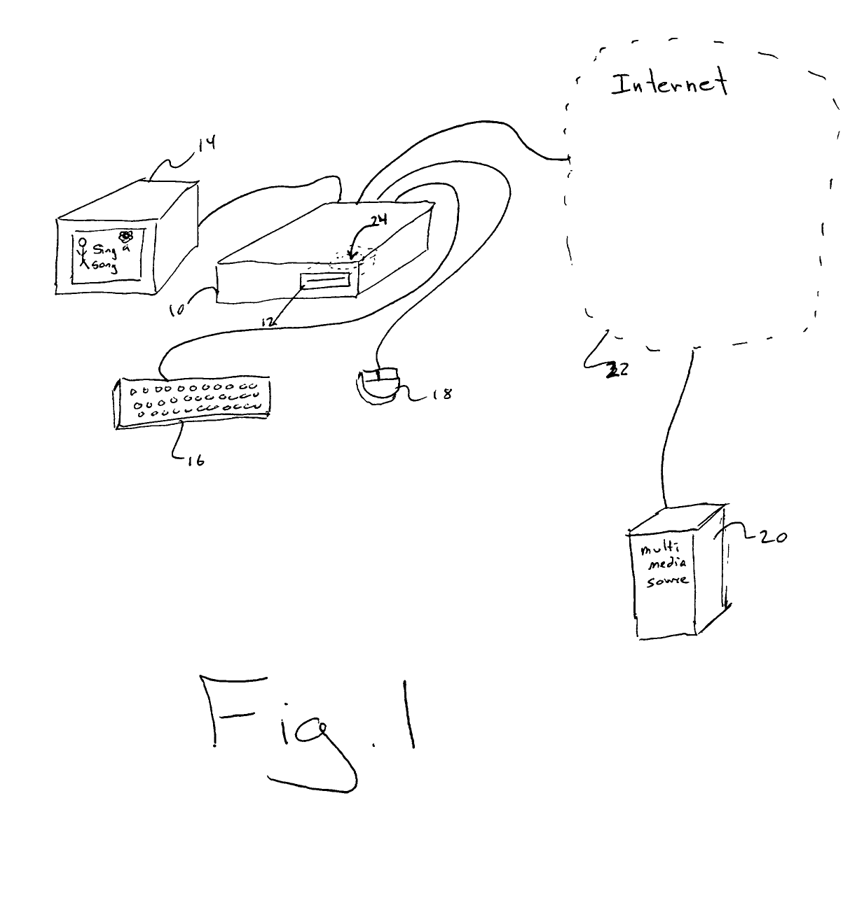

FIG. 2 is a high level flow chart of the present invention a method for combining multimedia data with audio data from a compact disc; and

FIG. 3 is a diagrammatic representation of a multimedia “title” employing the present invention.

### DETAILED DESCRIPTION OF VARIOUS ILLUSTRATIVE EMBODIMENTS

Although the present invention is particularly well suited for “Red Book” format audio CDs and shall be so described, the present invention is equally well suited for use with other digital audio formats.

In 1981, Sony Corporation and Philips N. V. jointly published a standard format for audio CDs called the “Red Book”, which established a uniform set of physical characteristics for the audio CD. As a result, manufacturers of CD players and media (discs) make their products the same way, thus permitting each audio CD to play and sound the same when put into any audio CD player.

A “Yellow Book” standard format was published in 1986 by Sony and Philips which defines the CD-ROM format for multimedia capable computers. Multimedia data is an integrated combination of multiple forms of media, including audio, video, text and graphics. The typical CD-ROMs that are purchased for use with a personal computer are in “Yellow Book” format. While the two formats, “Red Book” and “Yellow Book”, are not compatible, there is a desire to have audio content and multimedia data on a single CD.

An “enhanced” or mixed CD was introduced in 1994 containing both “Red Book” audio tracks and “Yellow Book” multimedia tracks of data. Unfortunately, these mixed mode CDs required that the first track be manually skipped when utilizing an audio CD player, because the first track contained the “Yellow Book” multimedia data. By 1996 most enhanced CDs hid the “Yellow Book” multimedia data in a gap before the first “Red Book” audio track. While this eliminated the requirement that the first track be skipped manually, it was still possible to skip back into the “Yellow Book” multimedia data which would produce a harsh undesirable sounding noise.

Sony and Philips have published a new standard, the “Blue Book”, which permits an audio CD player to read the audio portion of the disc without having to process the multimedia portion of the disc. This standard finally permitted an enhanced CD to be made that plays and sounds exactly like a standard “Red Book” format audio CD. Essentially, a “Blue Book” enhanced CD is a CD which combines “Red Book” audio data and “Yellow Book” multimedia data on a single manufactured disc and retains “Red Book” compatibility and compliance with the “Yellow Book” multimedia format.

To play a “Blue Book” enhanced CD in the CD-ROM drive of a personal computer it is necessary to have software drivers that are capable of reading multi-session discs. Without the proper drivers, the personal computer will not be able to access the disc's interactive multimedia features. Additionally, the CD-ROM drive of the personal computer must be multi-session capable, otherwise the CD-ROM drive will not be able to properly recognize that it is reading a “Blue Book” enhanced CD.

In order to take advantage of the features of an enhanced CD, in addition to the requirements that the CD-ROM drive and software drivers must be multi-session capable, the existing libraries of “Red Book” format audio CDs must be replaced by new “Blue Book” format CDs. In other words, the Red Book format prevents the application of the new interactive multimedia capabilities to existing audio libraries. The present invention, a method for combining multimedia data with audio data from a compact disc, permits the owners of libraries of “Red Book” format audio CDs to take advantage of features of the interactive multimedia capabilities of the newer “Blue Book” format Cds. The present invention does not require that the multimedia data be in “Blue Book” format nor does it require that the multimedia data be on the CD itself with the audio. The present invention allows a user to control and interact with any “Red Book” audio CD in the user's CD-ROM drive by accessing multimedia data through an independent multimedia data source. For the preferred embodiment of the invention, such a multimedia data source will be accessed through the World Wide Web (WWW) over the Internet. This gives the user the ability to view animation, reading information (such as song books), sound clips and more, all synchronized with the music on the original “Red Book” audio CD.

Additionally, the system and method of the present invention for combining multimedia data with audio data from a compact disc, permits the interactive multimedia data to be dynamic and time sensitive. The data may be varied by an external agent in response to user actions as well as other factors. Unlike a “Blue Book” format CD, which has its multimedia data fixed at the time of creation of a master, the present invention permits updating of the multimedia data on a subscription basis as well as the dynamic generation of alternative formats of data tailored to the particular user.

In an exemplary embodiment of the present invention, the multimedia data is downloaded into the cache of a user's WWW browser and played using a compatible browser plug-in. The multimedia data is linked to particular sections of “Red Book” format audio data on the CD through a plug-in for a CD link (player), which provides the expanded capabilities to enable the browser plug-in (CD link) to link to a “Red Book” format audio CD loaded in the user's CD-ROM drive.

When using the present invention, the system checks during a verification process to determine that the proper “Red Book” format CD is installed in the CD-ROM drive. If no audio CD or the wrong audio CD is installed, a corresponding error message is displayed directing the user to take the appropriate action to rectify the problem. When the audio CD corresponding to the multimedia data is installed, the linked multimedia session and the audio CD can start. The verification also provides a way of limiting access to a given multimedia title to the owners of the CD as well as preventing the wrong CD from being linked which would result in a multimedia presentation that does correspond with what the listener is hearing.

In such an exemplary embodiment, the multimedia presentation can provide an introduction to the band name, album title and album art work, then loop through photographs of the band. One example is an interactive song book. In this case, song lyrics would appear graphically on the computer screen. By clicking on a particular line of lyrics, the audio CD would begin to play at the location corresponding to that lyric. As the audio CD continues to play, the lyrics can track the progress of the song, providing a high tech equivalent of follow the bouncing ball. Audio explanations of the songs, and even video type games of skill as well as trivial question contests can be linked. In an academic environment with Jazz, Classical and other music formats a multimedia course can be offered which links to existing audio CD and provides specialized subject matter.

The dynamic nature of the source of the multimedia data will permit updates which can include recent concert clips, concert information and other current news. It is possible to establish multimedia data designed for fan clubs and other groups. The multimedia data can be down loaded on request or supplied on a subscription basis such as an attachment through e-mail, by FTP (File Transfer Protocol), through a Java Applet, “Push” technology, and other methods of information distribution. Once the multimedia data has been down loaded it is no longer necessary to be connected to the source network.

In addition to a download-then-play embodiment, the present invention is equally well suited for use in a streaming model. In the streaming embodiment, playback begins as soon as the minimal required elements and components have been streamed rather than waiting until the download is completed.

Referring to FIG. I there is shown a diagram of a computer system utilizing the present invention. A personal computer (PC) 10, contains a “Red Book” compatible CD ROM drive 12. While the present invention is described being used with a PC 10, it is equally well suited for use with a Web TV system, workstation, and other computerized devices interfaced with a “Red Book” format compatible CD ROM drive. The PC 10 is coupled to a video monitor 14, keyboard 16 and a mouse 18. A multimedia source 20 which contains the multimedia data linked to a corresponding “Red Book” CD is linked, for example, to the PC 10 through the Internet 22. Alternatively, the linked multimedia data can be linked to the PC 10 through other networks, and even by the physical transfer of recorded magnetic or optical media. A “Red Book” format CD 24 is mounted on the CD ROM drive 12.

While typically, the individual objects in multimedia data are associated and linked with the audio data in “Red Book” format using a multimedia editor, it is not necessary that the editor be object oriented. In an object oriented environment images, animation, video, text and sound are handled as objects which can be assigned properties, such as colors, and inherit behaviors from other objects, such as animating an object across a path. In the object oriented environment the relationship and interaction of the objects is defined and manipulated. The objects interact with each other and the user by exchanging messages. The primary task of an author is to assemble the objects, define their properties, and to write the messages to enable the objects to interact. In one example, words in a song book are synchronized to the audio data. A moving object, such as a bouncing ball or daisy can be animated to follow the synchronized interaction.

Traditionally the objects that are manipulated are imported to the multimedia environment. The relationship and interactions of the objects are then defined, resulting in the creation of a complete “title”. The “title” typically utilizes a separate player for execution rather than containing the player, so that only one copy of the player has to be stored.

Object oriented editors and other manipulative systems have been extended to enable the delivery and dynamic behavior of Internet based multimedia applications. This is accomplished through the development of plug-in players for Internet browsers. The entire “title” can be down loaded, or scene based and object based streaming and compression can be used to minimize response time when accessing a “title”. The completed multimedia data is then run directly as an executable or through a web browser.

The present invention system for combining multimedia data with audio data from a compact disc takes the unique approach of not having the Internet “title” contain all the objects that are manipulated within the “title”. The additional objects include an existing “Red Book” CD for audio data. This both extends the capabilities of the existing “Red Book” CD as well controlling or limiting the functioning of the multimedia data to users who have the corresponding “Red Book” CD.

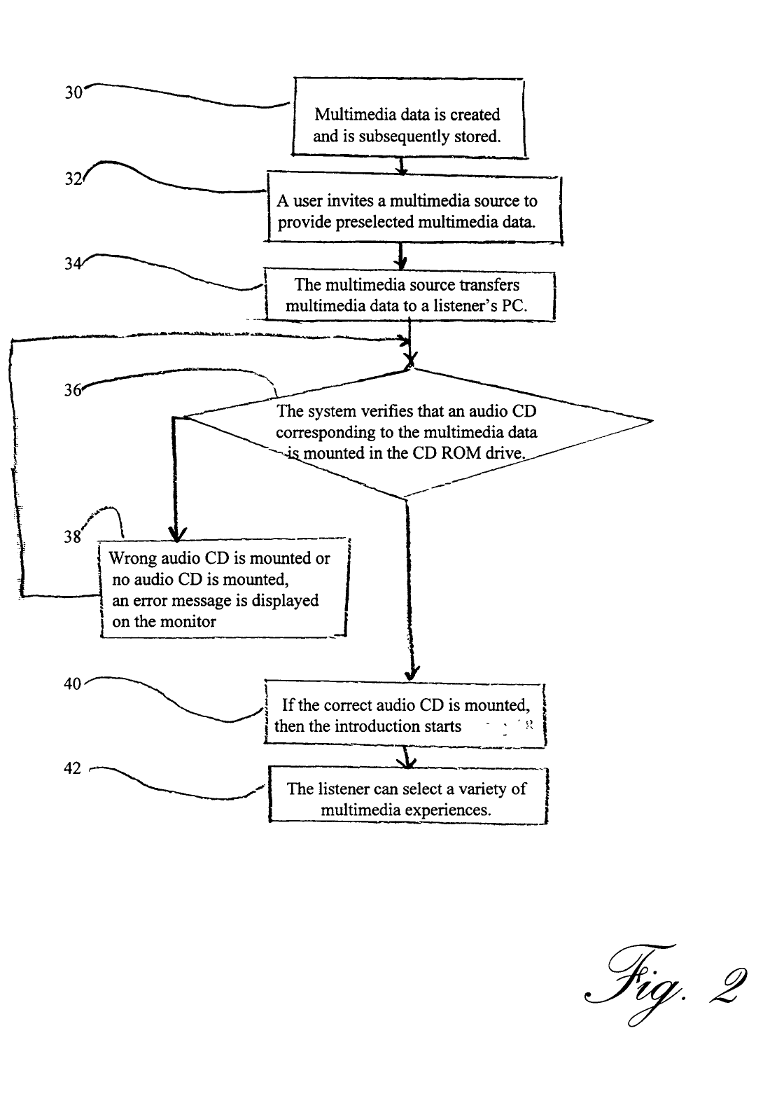

Referring to FIG. 2, there is shown a high level flow chart of the steps relating to the present invention. In step 30, multimedia data is created and is subsequently stored at a multimedia source 20. A user, in step 32, invites the multimedia source 20 to provide preselected multimedia data. This invitation may be made by selection options on a WWW browser screen, through establishing a subscription arrangement with the multimedia source 20, through the use of push technology as well as other methods. In step 34, the multimedia source 20 transfers multimedia data to a listener's PC 10. This transfer can be initiated by a user agent through the Internet 22, through other networks or through the physical distribution of a media containing the data. In step 36, the system verifies that an audio CD 24 corresponding to the multimedia data is mounted in the CD ROM drive 12. If the wrong audio CD 24 is mounted or no audio CD is mounted, an error message is displayed on the monitor 14 in step 38 (or alternatively an audio error message is provided) and then the system proceeds to step 36 again after a suitable pause or delay. If the correct audio CD 24 is mounted, then the introduction (menu, etc.) starts in step 40. The listener can select a variety of multimedia experiences in step 42.

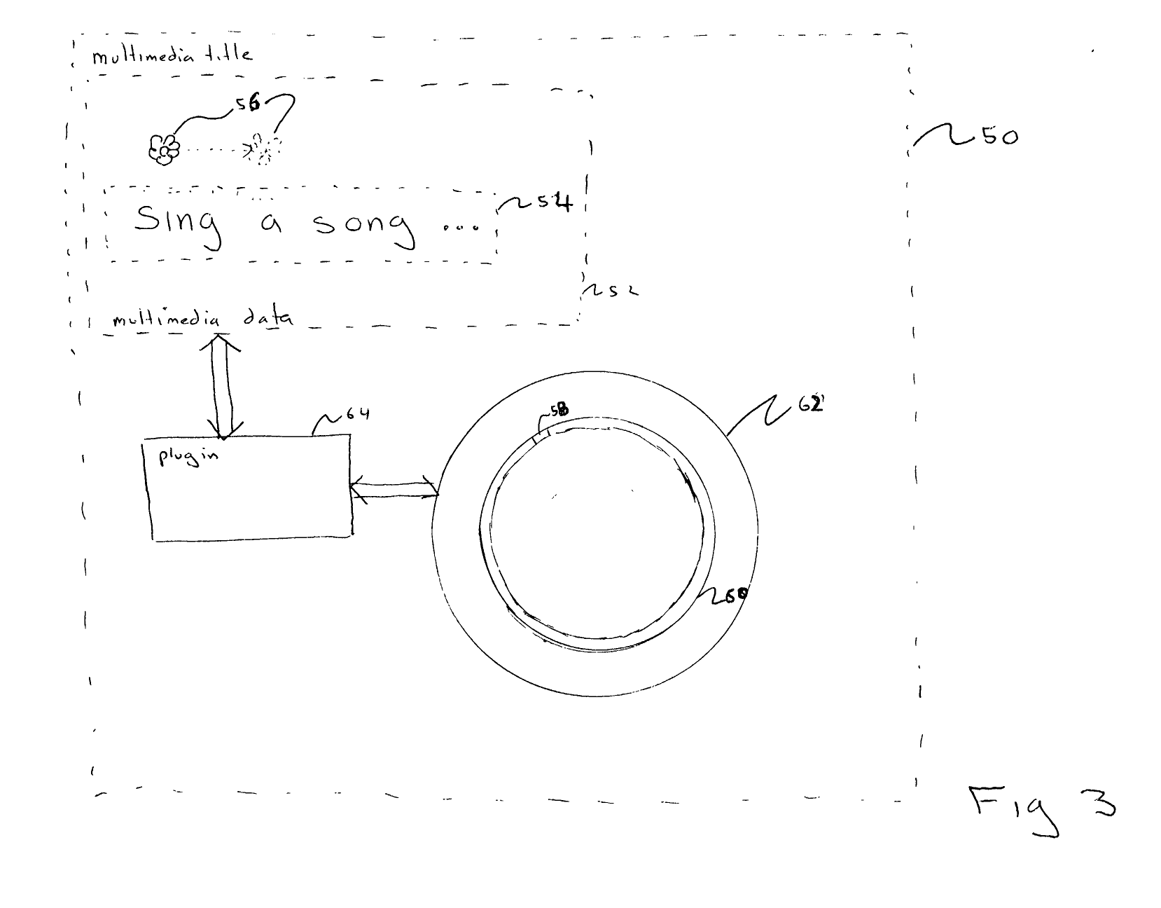

Referring to FIG. 3, there is shown a diagrammatic representation of a multimedia “title” employing the present invention. The multimedia “title” 50, in this example contains multimedia data 52 which is a textual song book object (textual object) 54 with a moving indicator object (graphic object) 56 such as a daisy. The multimedia data 52 is linked to a particular reference point of audio data 58 on a particular data track 60 on an audio CD 62 (external audio object). The textual object 54 is synchronized to the external audio object such that the relative position of the graphic object 56 with respect to the textual object 54 corresponds to a particular reference point of audio data 58. Changing the particular reference point of audio data 58 results in a corresponding change in the relative position of the graphical object 56. Thus, as the audio CD 62 is played the graphical object 56 moves its relative position to track the words in the textual song book 54. In a complementary fashion, accessing a particular position with respect to the textual object 54 will synchronize the audio CD 62 so that the song starts to play at the corresponding point. The interfaces between the external audio object and the multimedia data 52 in the multimedia “title” 50 are handled by a WWW browser plug-in 64 which provides additional functions for controlling the CD-ROM drive, thus combining multimedia data 52 in the form of a multimedia “title” 50 with an existing audio CD 62.

The creation and linking of the multimedia data to the “Red Book” audio CD according to the method of the invention may be carried out utilizing any of a variety of software tools that will be known to those skilled in the art. In particular, one such software tool, Director®, from Macromedia, Inc., 600 Townsend St., San Francisco, Calif. 94103 USA, allows the creation of various multimedia productions. Shockwave™ by Macromedia, Inc. is a plug-in which allows for Director® developed multimedia pieces to be viewed over the Internet. This information is documented in the Macromedia, Inc. Director® 6 manuals (which are incorporated herein by reference).

While tools such as Director® are multi-faceted programs capable of a wide variety of tasks, some features are not supported. For example, there is no built-in way to control a computer's CD-ROM drive from within the program. One aspect of the production process for the present invention system and method for adding multimedia data to an existing audio compact disc relies on accessing and controlling the audio CD in the user's CD-ROM drive. Modules of software which extend the capabilities for Director® are referred to as an Xtra™. In one embodiment, the present invention utilizes a particular Xtra™, called CDPro™, which provides additional functions for controlling the CD-ROM drive. For example, a function call such as “play 5” can be made and the fifth track on the audio CD in the CD-ROM drive will be played.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claim is reserved.

What is claimed:

1. A method for combining multimedia data with audio data from a compact disc, said method comprising the steps of:
transferring multimedia data from a source independent of the compact disc to a computer system enabled to interface with a transcription means adapted to read audio data stored in the compact disc;
instructing said computer system to cause synchronization of one or more selected portions of said multimedia data and a corresponding portion of audio data stored in the compact disc; and
providing an audio-visual output representing synchronized multimedia data and said audio data.

2. The method as recited in claim 1 further comprising the step of verifying that the compact disc corresponds to said multimedia data.

3. The method as recited in claim 1 further comprising the step of linking multimedia data to said audio data stored in the compact disc.

4. The method as recited in claim 1 further comprising the step of creating multimedia data corresponding to the compact disc.

5. The method as recited in claim 1 wherein said audio data is stored in red book format.

6. The method as recited in claim 1 wherein said multimedia data is time sensitive.

7. The method as recited in claim 1 wherein said audio-visual output varies dynamically in response to parameters selected by a user of said computer system.

8. The method as recited in claim 7 wherein said parameters originate from an external source.

9. A system for combining multimedia data with audio data from a compact disc, the system comprising:
transfer means for transferring multimedia data from a source independent of the compact disc to a computer system enabled to interface with a transcription means adapted to read audio data stored in the compact disc; and
instruction means for instructing said computer system to cause it to operate to synchronize one or more selected portions of said multimedia data and a corresponding portion of audio data stored in the compact disc.

10. The system as recited in claim 9 further comprising an audio-visual device for providing audio-visual output representing synchronized multimedia data and said audio data.

11. The system as recited in claim 9 further comprising a means for verifying that the compact disc corresponds to said multimedia data.

12. The system as recited in claim 9 further comprising a means for linking multimedia data to said audio data stored in the compact disc.

13. The system as recited in claim 9 further comprising a means for creating multimedia data corresponding to the compact disc.

14. The system as recited in claim 9 wherein said audio data is stored in red book format.

15. The system as recited in claim 9 wherein said multimedia data is time sensitive.

16. The system as recited in claim 9 wherein said audio-visual output varies dynamically in response to parameters selected by said user.

17. The system as recited in claim 16 wherein said parameters originate from an external source.
